(19) United States
(12) Patent Application Publication
(10) Pub. No.: US 2026/0226885 A1
(43) Pub. Date: Aug. 6, 2026

(54) QUICK RELEASE SCOTCH YOKE ACTUATOR

(71) Applicant: BRAY INTERNATIONAL, INC., Houston, TX (US)

(72) Inventor: Nipun NANAYAKKARA, Houston, TX (US)

(21) Appl. No.: 19/450,550

(22) Filed: Jan. 15, 2026

Related U.S. Application Data
(60) Provisional application No. 63/754,098, filed on Feb. 5, 2025.

(51) Int. Cl. F03G 1/02

(52) U.S. Cl. CPC F03G 1/024

(57) ABSTRACT

The disclosure relates to a quick release apparatus for a scotch yoke actuator having a pressure module and a spring module, and a torque module between and connecting the pressure module and the spring module, including a main drive shaft extending out of the spring module towards the torque module; a cylinder shaft extending out of the pressure module and towards the torque module; and a latch mechanism releasably connecting the main drive shaft to the cylinder shaft.

### BACKGROUND

### Technical Field

The disclosure relates to the field of scotch yoke actuators.

Conventional scotch yoke actuators which require fast spring return strokes need to rely on complex pneumatic accessories such as high Cᵥ solenoids, quick exhaust and dump valves to rapidly depressurize the air cylinder side. These solutions are costly, complex and often greatly increase the size associated with the scotch yoke actuator and thus affect the entire automated assembly.

Therefore a need exists for an improved quick release scotch yoke actuator. By utilizing the improved quick release scotch yoke actuator, the issue of getting air out of the cylinder may be eliminated, such as via the addition of external accessories, thus decreasing the cost, complexity and size associated with the automated assembly.

### SUMMARY

The disclosure relates to a quick release apparatus for a scotch yoke actuator having a pressure module and a spring module, and a torque module between and connecting the pressure module and the spring module, including a main drive shaft extending out of the spring module towards the torque module; a cylinder shaft extending out of the pressure module and towards the torque module; and/or a latch mechanism releasably connecting the main drive shaft to the cylinder shaft; and/or a recess defined on the cylinder shaft; and/or a chamfer on an end of the cylinder shaft; and/or wherein the latch mechanism comprises a pin inserted into the recess of the cylinder shaft, wherein the pin is configured to be retractable into and out of the recess; and/or a pin spring on the pin, wherein the pin spring biases the pin towards the recess.

The disclosure relates to a method for a quick spring stroke in a scotch yoke actuator having a pressure module and a spring module, and a torque module between and connecting the pressure module and the spring module, including the steps of retracting a pin from a recess defined on a cylinder shaft extending from the pressure module and towards the torque module; decoupling the cylinder shaft from a main drive shaft, wherein the main drive shaft extends from the spring module towards the torque module; and/or rapidly moving the main drive shaft away from the torque module; and/or rapidly expanding a spring within the spring module; and/or recoupling the cylinder shaft to the main drive shaft; and/or wherein the step of recoupling the cylinder shaft to the main drive shaft comprises the steps of sliding the pin over a chamfered end of the cylinder shaft, and inserting the pin back into the recess; and/or a pin spring on the pin, and/or biasing the pin via the pin spring towards the recess; and/or wherein the step of retracting the pin is accomplished via a solenoid device; and/or wherein the step of retracting the pin is accomplished via a pneumatic device.

The disclosure also relates to method for a quick spring stroke in a scotch yoke actuator having a pressure module and a spring module, and a torque module between and connecting the pressure module and the spring module, having the steps of depressurizing the pressure module which has been previously pressurized; and/or decoupling a cylinder shaft from a main drive shaft, wherein the cylinder shaft extends from the pressure module and towards the torque module, wherein the main drive shaft extends from the spring module towards the torque module; and/or moving the main drive shaft away from the torque module at a first speed; and/or moving the cylinder shaft towards the torque module at a second speed; and/or wherein the first speed and the second speed are different; and/or wherein the step of decoupling the cylinder shaft from the main drive shaft comprises the step of releasing a latch from a recess defined on the cylinder shaft; and/or further comprising the step of automatically recoupling the cylinder shaft to the main draft shaft as the depressurizing step progresses by inserting the latch back into the recess; and/or wherein a stroke speed for the spring module is less than 0.5 seconds.

### BRIEF DESCRIPTION OF THE DRAWINGS

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts a side cross section view of an exemplary embodiment of an improved scotch yoke actuator.

FIG. 2 depicts an enlarged side cross section view of an exemplary embodiment of a quick release device for the improved scotch yoke actuator of FIG. 1.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

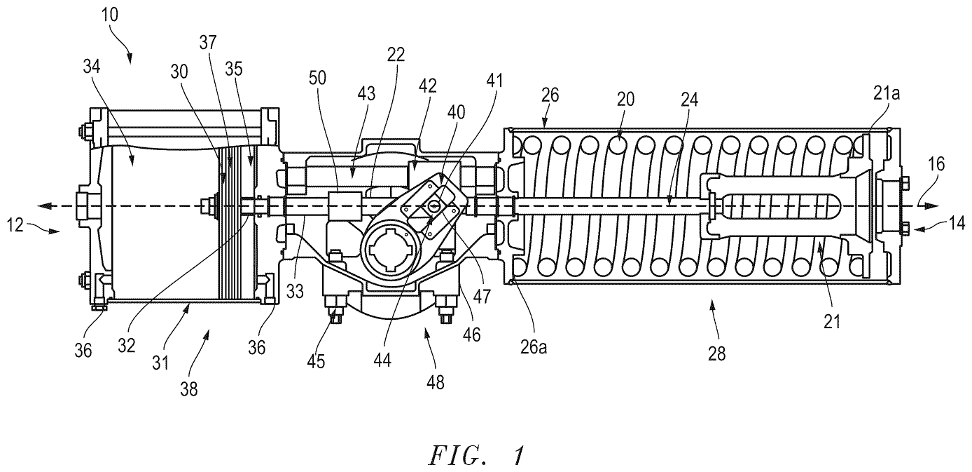

FIG. 1 depicts a cross section view of an exemplary embodiment of an improved scotch yoke actuator 10 having a quick release device 50. The improved scotch yoke actuator 10 defines a first end 12 and a second end 14, including a pressure module or air cylinder 38 (optionally as a hydraulic pressure module 38) towards the first end 12, a spring module 28 towards the second end 14, and a torque module 48 located between and connecting the pressure module 38 and the spring module 28.

The pressure module 38 includes a barrel 31 which houses a piston 30 mounted on a piston rod 32, and defines one or more ports 36 which allow the input and output of media to and from the barrel 31. There may be a first port 36 towards the first end 12 of the pressure module 38 and above the piston 30 and in a first chamber 34 of the barrel 31 or pressure module 38; and a second port 36 towards the second end 14 of the pressure module 38 and below the piston 30 and in a second chamber 35 of the barrel 31 or pressure module 38. The first chamber 34 and the second chamber 35 are separated by the piston 30. The piston 30 may further include one or more seals 37 around the perimeter of the piston 30 which sealingly engages the inner surface of the barrel 31 and prevents the migration or flow of media between the two chambers 34, 35 of the pressure module 38 or barrel 31. The piston rod 32 may be the same as, connected to, or continuous with an air cylinder shaft 33 (or cylinder shaft 33) which extends out of the barrel 31 at towards the second end 14 of the barrel 31 and towards the torque module 48.

The spring module 28 includes a housing or pipe 26. A spring rod 24 is inserted into the pipe 26 towards the first end 12 of the pipe 26, and is connected to a spring guide 21 located nearer towards the second end 14 of the pipe 26. The spring guide 21 may include a flange or flange support 21a. A compressible spring 20 is located between the first end of the pipe 26 and the spring guide 21, and wherein the spring 20 is mounted around the spring rod 24, and further wherein an end of the spring 20 may rest on the flange 21a. The spring guide 21 and the spring rod 24 are movable towards and away from the first end of the pipe 26 (or towards the torque module 48), and the spring 20 is compressible between the first end of the pipe 26, such against the pipe shoulder 26a, and the flange 21a of the spring guide 21. The spring rod 24 may be the same as, connected to, or continuous with a main drive shaft 22 extending out of the pipe 26 towards the torque module 48.

The torque module 48 includes a housing or torque module housing 46 into which the cylinder shaft 33 and the main drive shaft 22 are inserted into towards the first end 12 and second end 14 of the housing 46, respectively. The cylinder shaft 33 and the main drive shaft 22 are releasably connected together via the quick release device or mechanism 50 within the torque module 48. In certain exemplary embodiments, the piston rod 32 or cylinder shaft 33 and the spring rod 24 or main drive shaft 22 may be aligned along the same longitudinal axis 16. A guide rod 43 may be installed into the housing 46 parallel to the cylinder shaft 33 and main drive shaft 22 and the longitudinal axis 16. A guide block 42 connects the guide rod 43 and the main drive shaft 22, wherein the guide block 42 is fixed to the main drift shaft 22 and slidable along the length of the guide rod 43. A yoke pin 41 may extend perpendicularly away from the guide block 42 and the longitudinal axis 16. The torque module 48 also includes a yoke 40 rotatably mounted to the housing 46, wherein the yoke 40 may be rotatable in a clockwise direction towards the spring module 28, and in a counterclockwise direction towards the pressure module 38; in alternative exemplary embodiments, these directionalities may be reversed. The yoke 40 defines an elongated slot, channel, or opening 47 into which the yoke pin 41 is inserted. The pin 41 may optionally be supported by a slider block 44 within the slot 47. As the main drive shaft 22 moves based on forces acting on the piston 30 and the spring 20, the yoke pin 41 responds by moving along the axis 16 and within and along the slot 47, and accordingly rotates the yoke 40 in a clockwise or counterclockwise direction. Stop bolts 45 inserted through the housing 46, towards the first end 12 and second end 14 of the torque module 48 may limit the motion of the yoke 40 beyond certain positions by physically preventing the rotational position of the yoke 40 at the ends of the stop bolts 45 and further, define the ends of travel for the yoke 40.

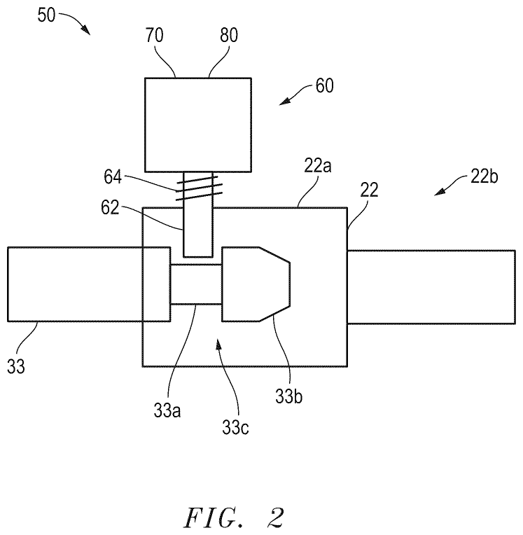

Referring further to FIG. 2, the quick release device, apparatus, or mechanism 50 is inline with the air cylinder shaft or cylinder shaft 33, along the axis 16, to quickly release the potential energy from the spring module 28. In alternative exemplary embodiments, the quick release device, apparatus, or mechanism 50 may be inline with the main drive shaft 22. The improved scotch yoke actuator 10 utilizes a quick release mechanism 50 that decouples the air cylinder shaft 33 from the yoke 40. This allows for the spring 20 stroke (fail state) to occur without having to wait for the air cylinder or pressure module 38 to depressurize resulting in a quicker stroke time for the spring 20 stroke. The air cylinder 38 will move at the standard rate as dictated by the air solenoid or pressure module 38. When the end of travel is reached for both the cylinder 38 and yoke 40 the mechanism 50 is re-engaged.

As shown in FIG. 2, an exemplary embodiment of the quick release mechanism 50 may be via a latching system 60 configured to take the load of the scotch yoke actuator 10. The quick release device 50 may be engaged in such a way that minimal force is needed to activate the quick release device 50. By way of example only, and not to be limited to, the minimal force for activating or initiating the quick release device 50 may be in the range of 10 to 50 pounds of force, or in range for an electromagnetic coil to activate. As shown in FIG. 2, an end 33c of the air cylinder shaft 33 may have a shaft recess or slot 33a with a reduced diameter or wherein the recess or slot 33a is inscribed into the air cylinder shaft 33; further the end 33c of the air cylinder shaft 33 may have a chamfered or beveled surface or rounded edge 33b. The end 33c of the air cylinder shaft 33, optionally including the chamfered surface 33b and the recess 33a, may be inserted into an end 22b of the main drive shaft 22. The end 22b of the main drive shaft 22 may have a coupler, connector, or receiver 22a into which the end 33c is inserted. The coupler, connector, or receiver 22a, may in certain exemplary embodiments, be an open tubing or housing which engages the end 33c of the air cylinder shaft 33. The latching system 60 includes a pin 62 inserted or fitted into the end 22b of the main drive shaft, optionally through the connector 22a, and into the slot 33a. A pin spring 64 may be mounted around the pin 62, which spring loads the pin 62 towards the recess 33a. The opposite end of the pin 62 may be connected to, by way of example only, a solenoid latch release 70, or a pneumatic latch release 80. In further alternate exemplary embodiments, the release of the latching system 60 may be via a manual operator.

When the spring 20 is fully or sufficiently compressed in the improved scotch yoke actuator 10, the latching system 60 disengages or removes the pin 62 away from the recess or slot 33a. As mentioned earlier, the disengagement of the pin 62 form the recess or slot 33a may occur via solenoid activation 70, pneumatic activation 80, or manual. This allows the main drive shaft 22 and the air cylinder shaft 33 to decouple once the pin 62 is out of the way or away from the recess 33a, and allows the spring 20 stroke to occur rapidly without waiting for the air cylinder 38 to depressurize. Thus the yoke 40 may rapidly or quickly rotate clockwise, the spring 20 expands or decompresses, and the main drive shaft 22 may rapidly or quickly move towards the end 14 as powered by the forces released by the compressed spring 20, without being limited by the connection to air cylinder shaft 33 and piston 30. By way of example only, and not to be limited to, the stroke speed for an exemplary embodiment for an improved scotch yoke actuator 10 having the quick release device 50 may be less than 0.5 seconds; moreover, the quick release device 50 may also eliminate the air solenoid 38 dwell time, which may be approximately in the range of 0.7 seconds for conventional scotch yoke actuators.

Further, the pin 62 is biased or spring loaded via the pin spring 64 and will reconnect the air cylinder shaft 33 and main drive shaft 22 automatically as air cylinder 38 depressurizes, and the end 33c of the air cylinder shaft 33 approaches and is inserted into the end 22b of the main drive shaft 22. The pin 62 will slide over the chamfer or bevel 33b and automatically slide back into the recess or slot 33a, as urged by the pin spring 64, thus automatically reconnecting the air cylinder shaft 33 and main drive shaft 22 for the next stroke.

While the exemplary embodiments are described with reference to various implementations and exploitations, it will be understood that these exemplary embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A quick release apparatus for a scotch yoke actuator having a pressure module and a spring module, and a torque module between and connecting the pressure module and the spring module, comprising
a main drive shaft extending out of the spring module towards the torque module;
a cylinder shaft extending out of the pressure module and towards the torque module; and
a latch mechanism releasably connecting the main drive shaft to the cylinder shaft.

2. The quick release apparatus of claim 1, further comprising a recess defined on the cylinder shaft.

3. The quick release apparatus of claim 2, further comprising a chamfer on an end of the cylinder shaft.

4. The quick release apparatus of claim 3, wherein the latch mechanism comprises a pin inserted into the recess of the cylinder shaft, wherein the pin is configured to be retractable into and out of the recess.

5. The quick release apparatus of claim 4, further comprising a pin spring on the pin, wherein the pin spring biases the pin towards the recess.

6. A method for a quick spring stroke in a scotch yoke actuator having a pressure module and a spring module, and a torque module between and connecting the pressure module and the spring module, comprising the steps of
retracting a pin from a recess defined on a cylinder shaft extending from the pressure module and towards the torque module;
decoupling the cylinder shaft from a main drive shaft, wherein the main drive shaft extends from the spring module towards the torque module; and
rapidly moving the main drive shaft away from the torque module.

7. The method of claim 6, further comprising the step of rapidly expanding a spring within the spring module.

8. The method of claim 7, further comprising the step of recoupling the cylinder shaft to the main drive shaft.

9. The method of claim 8, wherein the step of recoupling the cylinder shaft to the main drive shaft comprises the steps of sliding the pin over a chamfered end of the cylinder shaft, and inserting the pin back into the recess.

10. The method of claim 9, further comprising a pin spring on the pin, and further comprising the step of biasing the pin via the pin spring towards the recess.

11. The method of claim 10, wherein the step of retracting the pin is accomplished via a solenoid device.

12. The method of claim 10, wherein the step of retracting the pin is accomplished via a pneumatic device.

13. A method for a quick spring stroke in a scotch yoke actuator having a pressure module and a spring module, and a torque module between and connecting the pressure module and the spring module, comprising the steps of
depressurizing the pressure module which has been previously pressurized;
decoupling a cylinder shaft from a main drive shaft, wherein the cylinder shaft extends from the pressure module and towards the torque module, wherein the main drive shaft extends from the spring module towards the torque module; and
moving the main drive shaft away from the torque module at a first speed;
moving the cylinder shaft towards the torque module at a second speed;
wherein the first speed and the second speed are different.

14. The method according to claim 13, wherein the step of decoupling the cylinder shaft from the main drive shaft comprises the step of releasing a pin from a recess defined on the cylinder shaft.

15. The method according to claim 14, further comprising the step of automatically recoupling the cylinder shaft to the main draft shaft as the depressurizing step progresses by inserting the pin back into the recess.

16. The method according to claim 13, wherein a stroke speed for the spring module is less than 0.5 seconds.
